(19) United States
(12) Patent Application Publication
(10) Pub. No.: US 2022/0151852 A1
(43) Pub. Date: May 19, 2022

(54) STRENGTH-REINFORCED SINGLE USE BEDPAN

(71) Applicant: HYGIENIUS INTELLECTUAL PROPERTY B.V., Breukelen (NL)

(72) Inventors: Ilja BOBBERT, Hilversum (NL); Ian Alexander WEBB, London (GB)

(21) Appl. No.: 17/594,123

(22) PCT Filed: Mar. 30, 2020
(86) PCT No.: PCT/NL2020/050218

§ 371 Date: Oct. 4, 2021

(30) Foreign Application Priority Data
Apr. 5, 2019 (NL) 2022870

(51) Int. Cl. A61G 9/00

(52) U.S. Cl. CPC A61G 9/003; A61G 2203/76

(57) ABSTRACT

The present invention relates to a single-use, maceratable bedpan (10) comprising: a main basin (12) that is defined by a bottom wall (14) and a circumferential wall (16) which is connected to the bottom wall and which extends upwards from the bottom wall, wherein the circumferential wall tapers outwardly in an upward direction, allowing nesting in a stack, an upper wall (22) which is connected to an upper edge (23) of the circumferential wall, wherein the upper wall extends over a horizontal distance outwardly away from said upper edge, at least a first support leg (24) and a second support leg (25) which extend downward from the upper wall, wherein each support leg comprises a circumferential leg wall (28) which is connected at an upper end thereof to the upper wall, wherein each circumferential leg wall tapers outwardly in an upward direction, wherein each support leg is hollow and defines a leg cavity, and wherein the upper wall defines a leg opening (31) at each upper leg, allowing nesting of support legs of different bedpans inside one another when a plurality of bedpans is stacked in a stack, wherein a gap (32) is defined between each circumferential leg wall (28) and the circumferential wall of the main basin.

### FIELD OF THE INVENTION

The present invention relates to a strength reinforced, single use, maceratable bedpan, that can be used without any support, in particular intended for use in a hospital or care environment. A further aspect of the invention is to provide a bedpan that avoids spillage when removing the filled bedpan.

### BACKGROUND OF THE INVENTION

Disposable, single use bedpans are known in the field of the art. For instance, WO2017/081601A1 discloses a bedpan having a base, electoral wall and an edge. U.S. Pat. No. 3,962,732 discloses another disposable bedpan having a similar configuration.

WO2017099850A1 discloses another type of bedpan comprising a base piece and a cover piece.

GB2508663A discloses a further bedpan comprising an insert.

NL7504766A discloses another bedpan having wing parts 14, see FIG. 6. NL7504766A is considered to form the closest prior art for the present invention.

Many requirements apply to a single-use, disposable bedpan. One requirement is that the bedpan should be maceratable. Maceration provides advantages with respect to infection prevention, time saving and ease-of-use. Macerators are used in hospitals on a wide scale. Therefore, if the bedpan is to be used in a hospital, it should be possible to dispose the bedpan in a customary way.

The bedpan should have a high load bearing capacity. Patients sit on the bedpan in use. A patient may be obese and have a considerable weight. The bedpan should not collapse under this load. It is noted that the load bearing requirement relates to strength, whereas maceration, in a sense, relates to weakness. These requirements are contradictory.

The bedpan should be able to cope with a wobbling patient and with an uneven mattress. The bedpan should provide a good stability in such conditions. A bedpan is preferably used without any further (plastic) support, so that the whole system is single-use and maceratable.

It should be possible and preferably relatively easy to push the bedpan underneath the patient. Sometimes patients are seriously ill (even terminally ill), having hip or back fractures, are immobile, and not capable of lifting themselves up from the mattress. In such conditions, a nurse should be able to push the bedpan underneath the patient.

The bedpan should also be nestable in a stack. In a hospital or other medical facility, large numbers of bedpans are used every day. The bedpans themselves have considerable dimensions, at least when a box shape extending around the bedpan is taken as a reference. If the bedpans are not stackable, the required storage space would be excessive and unpractical. For this reason, it is important that the bedpans can be nested into a stack with a small as possible nesting pitch (distance between 2 stacked bedpans) which occupies relatively little space.

Other criteria apply, such as that the bedpan should be leak free and easy to carry by a nurse after usage (when the bedpan is filled with urine and/or faeces). Preferably the bedpan can be covered after use with a cover that is sturdy and stays on the bedpan while walking and moving. In one aspect of the invention, the cover is connected to the bedpan and acts as a so-called ‘splashguard’ to effectively channel urine into the bedpan.

None of the bedpans as disclosed in the prior art mentioned above fulfill all these criteria. In particular, under the heavy load of the user the bedpan tends to tear when being pushed under the buttocks of user. This is a result of the combination of the use of pulp material and the substantial shear forces exerted on the bedpan during the sideways movement underneath the user. Therefore, often bedpans require a plastic, reusable support, which is highly undesirable in a single-use system.

### SUMMARY OF THE INVENTION

In order to achieve at least one object, a strong, single-use, bedpan is provided, comprising:
a main basin that is defined by a bottom wall and a circumferential wall which is connected to the bottom wall and which extends upwards from the bottom wall, wherein the circumferential wall tapers outwardly in an upward direction, allowing nesting in a stack,
an upper wall which is connected to an upper edge of the circumferential wall, wherein the upper wall extends over a horizontal distance outwardly away from said upper edge,
at least a first support leg and a second support leg which extend downward from the upper wall, wherein each support leg comprises a circumferential leg wall which is connected at an upper end thereof to the upper wall, wherein each circumferential leg wall tapers outwardly in an upward direction, wherein each support leg is hollow and defines a leg cavity, and wherein the upper wall defines a leg opening at each upper leg, allowing nesting of support legs of different bedpans inside one another when a plurality of bedpans is stacked in a stack, wherein a gap is defined between each circumferential leg wall and the circumferential wall of the main basin.

An advantage of the present invention is that the risk that the bedpan tears during the sideways movement under the buttocks of the user is smaller than with bedpans according to the prior art.

In an embodiment, the bedpan may be deformable, in particular by the force required to push the bedpan under the buttocks of a user, allowing the support legs to pivot inward towards the circumferential wall of the main basin, wherein the gap reduces and at least partially disappears as a result of the pivoting movement, and wherein as a result of the deformation the support legs engage the circumferential wall of the main basin and find support against the circumferential wall of the main basin.

In an embodiment, at each lower end of each support leg the gap between the circumferential leg wall and the circumferential wall of the main basin is 3-30 mm in a non-deformed state of the bedpan, preferably 4-20 mm, most preferably 5-10 mm.

In an embodiment, the gaps between the respective support legs and the circumferential wall of the main basin extend over the entire height of the support legs.

In an embodiment, the support legs are not directly connected to one another, but only via the upper wall.

In an embodiment, the bottom wall of the main basin defines a reference plane, and when seen in side view the lower ends of the support legs are located on said reference plane or at a distance above said reference plane.

In an embodiment, the first support leg is positioned on a right side of the main basin of the bedpan and the second support leg is positioned on a left side of the main basin of the bedpan.

In an embodiment, when seen in top view at least the lower ends of the first and second support legs are positioned at a rear half of the bedpan.

In an embodiment, the bedpan comprises exactly four support legs, two right support legs and two left support legs.

In an embodiment, at least one support leg is positioned at a right rear corner of the upper wall and at least one support leg is positioned at a left rear corner of the upper wall.

In an embodiment, when seen in top view, one or more legs, in particular the right and left leg, more in particular the forward right leg and the forward left leg, have an elongate cross-section, a leg width (LW1) being smaller than a leg length (LW2) (see FIG. 10).

In an embodiment, the gaps between the circumferential walls of the respective support legs and the circumferential wall of the main basin increases when traveling downward from the upper wall and reaches a maximum at the lower ends of the support legs.

In an embodiment, when seen in top view the main basin comprises a rear basin region and a forward basin region and a waist region, wherein a width of the forward basin region is smaller than a width of the rear basin region, wherein in particular waist region interconnects the rear basin region with the forward basin region, and wherein the rear width of the rear basin region and a forward width of the forward basin region are greater than a width of the waist region.

In an embodiment, when seen in top view the rear region has a rear basin centre , and wherein the cross section of each leg has a leg centre, wherein the two leg centres of the forward legs are positioned forward of said rear basin centre and the two legs centres of the rear legs are positioned to the rear of said rear basin centre.

In an embodiment, when seen in top view the leg centres of the legs are positioned relative to the rear basin centre as follows: at the 1 to 3 o'clock position, at the 9 to 11 o'clock position, at the 3 to 6 o'clock position and at the 6 to 9 o'clock position, the 12 o'clock position being the centre forward direction.

In an embodiment, the four support legs are configured to flex inwardly, wherein the two forward support legs are configured to find support against respective portions of the circumferential wall of the basin which face outwardly and forwardly and wherein the two rear support legs are configured to find support against respective portions of the circumferential wall of the basin which face outwardly and rearwardly.

In an embodiment, when seen in top view a cross-section of the leg cavities of at least some of the support legs is curved, wherein a part of the circumferential leg wall that faces the circumferential wall of the main basin is concave and a part of the circumferential leg wall that faces said concave part is convex.

In an embodiment, a width of the forward basin region is smaller than a width of the rear basin region.

In an embodiment, the circumferential wall of the main basin and the circumferential leg walls taper outwardly at a nesting angle of 1-8 degrees.

In an embodiment, each of the support legs has a leg bottom wall which closes off a lower end of the support leg.

In an embodiment, the bedpan is a single-part bedpan, or wherein the bedpan comprises a basin part and a separate lid part.

In an embodiment, the circumferential wall of the main basin, the bottom wall of the main basin, the upper wall, and the circumferential leg wall of the support legs are integral with one another.

In an embodiment, the bedpan is manufactured from a pulp material that can be based on paper, cardboard, bagasse, bamboo, wheatgrass, etc. and combinations thereof.

In an embodiment, the legs do not form part of the outer rim of the bedpan and are located to the inside of the outer rim.

In an embodiment, when seen in side view the bottom wall extends at an angle of 2-15 degrees to the upper wall.

In an embodiment, the bedpan comprises one or more overflow channels which form a depression in the upper wall and which extend between the support legs and the main basin. These optional overflow channels effectively reduce spillage of the bedpan contents when removing the bedpan from the patient of when walking around.

In an embodiment, the bedpan comprises additional support legs which rise up from the bottom wall of the main basin.

In an embodiment, the bedpan comprises two, three, four, five, six or more support legs.

These and other aspects of the invention will be more readily appreciated as the same becomes better understood by reference to the following detailed description and considered in connection with the accompanying drawings in which like reference symbols designate like parts.

### BRIEF DESCRIPTION OF THE FIGURES

FIG. 1 shows a top view of an embodiment of the invention.

FIG. 2 shows an isometric view of an embodiment of the invention.

FIG. 3 shows a front view of the embodiment of FIG. 1.

FIG. 4 shows a side view of the embodiment of FIG. 1.

FIG. 5 shows a rear view of the embodiment of FIG. 1.

FIG. 6 shows an isometric view from below of the embodiment of FIG. 1.

FIG. 7 shows a bottom view of the embodiment of FIG. 1.

FIGS. 8 and 9 show further isometric views of the embodiment of FIG. 1.

FIG. 10 shows a bottom view of the embodiment of FIG. 1.

FIGS. 11 and 12 show the forces acting on an embodiment of the invention.

FIG. 13-16 show a second embodiment of the present invention.

FIG. 17 shows a third embodiment of the present invention where anti-spill channels are located in the edge of the main basin, providing an overflow into the legs

FIG. 18, 19, 20 show a fourth embodiment of the present invention.

FIG. 21 shows another embodiment of the present invention, where the splashguard is directly connected to the bedpan

FIGS. 22 and 23 show another embodiment of the present invention.

FIGS. 24 and 25 show again another embodiment of the present invention.

FIGS. 26, 27 and 28 show the invention in an embodiment with a splashguard in use.

### DETAILED DESCRIPTION OF THE FIGURES

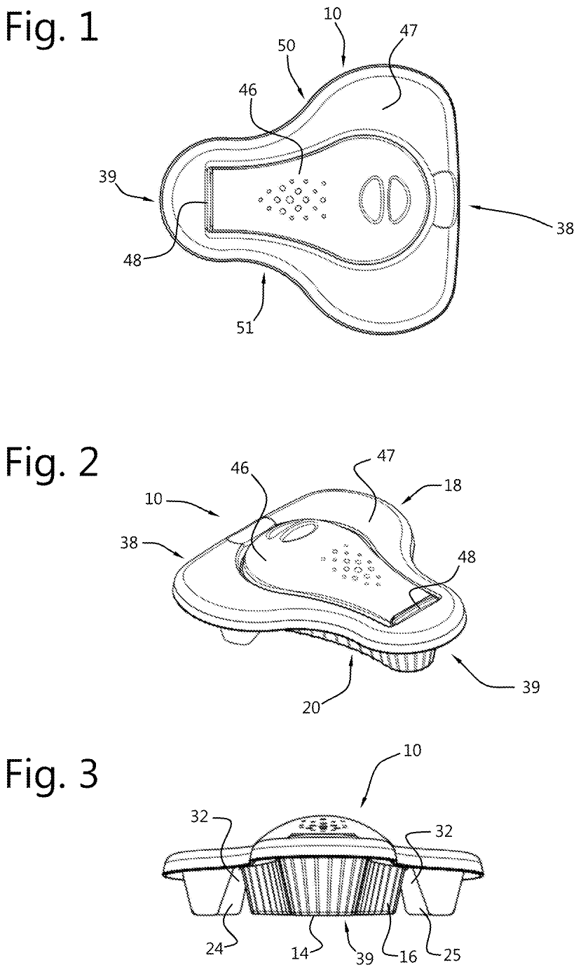

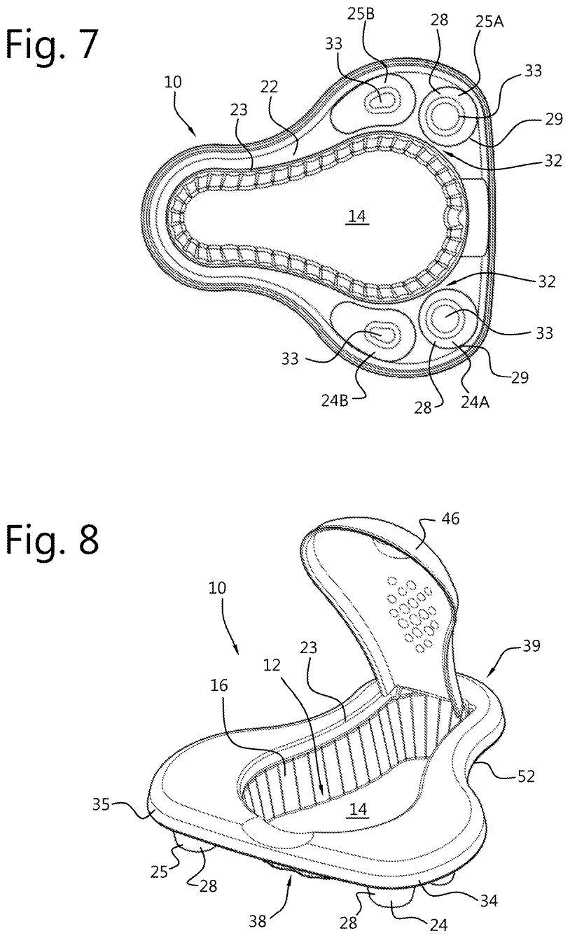

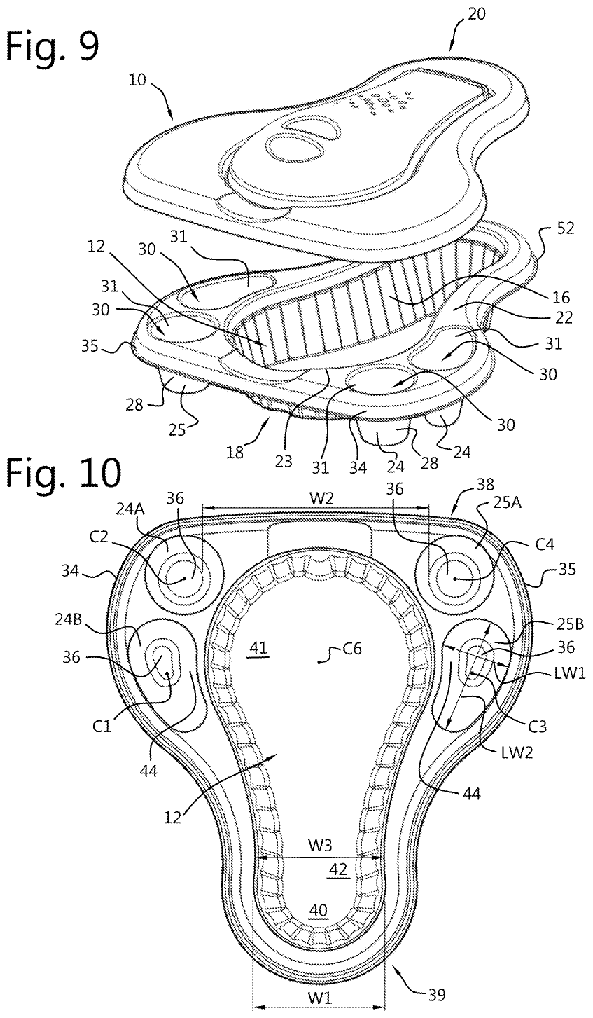

Turning to FIGS. 1-9, a single-use, maceratable bedpan 10 is shown. The bedpan may be manufactured from a pulp material, for instance newspaper pulp, thicker (office) paper pulp, carton pulp, bagasse pulp, wheat straw pulp, corn leaves, banana leaves, etc., or a mixture of these. After extrusion from a mould, the pulp material may be hot-pressed or air dried. The pulp bedpans can be produced using a wet-press mould and/or an oven dry technique.

The bedpan comprises a main basin 12 that is defined by a bottom wall 14 and a circumferential wall 16 which is connected to the bottom wall and which extends upwards from the bottom wall. The circumferential wall tapers outwardly in an upward direction, allowing nesting of a plurality of bedpans 10 in a stack.

The bedpan 10 has a front side 39 and a rear side 38. The rear side defined as the side which in use is positioned on the rear side of the user.

In this embodiment, the bedpan 10 comprises a separate basin part 20 and a lid part 18. The lid part fits 18 on top of the basin part 20 and is removably connected thereto. The lid part 18 is nestable in a stack of lid parts, and the basin part 20 is nestable in a separate stack of basin parts. The circumferential wall 16 of the main basin, the bottom wall 14 of the main basin, the upper wall 22, and the circumferential leg walls 28 of the support legs 24, 25 are integral with one another.

The lid part 18 comprises a pivotable lid 46 which is connected to a circumferential cover section 47 via a hinge 48. The lid 46 acts as a splash guard in use and prevents splashing or spilling of urine when used. The hinge 48 is located at the front side of the bedpan 10.

The bedpan, in particular the basin part 20 thereof, comprises an upper wall 22 which is connected to an upper edge 23 of the circumferential wall 16. When the lid part 18 is positioned on the basin part 20, the cover section 47 covers the upper wall 22 of the basin part 20.

The upper wall 22 extends over a horizontal distance outwardly away from said upper edge 23. and forms an upwardly facing support area for supporting the buttocks of a user. When seen in side view the bottom wall 14 extends at an angle of 2-15 degrees to the upper wall 22. To this end, the circumferential wall 16 is higher at the front end 39 than at the rear end 38.

The upper wall 22 has an outer rim 52 which projects downwards. The outer rim 52 facilitates the holding of the bedpan 10 by the user with his/her hands. Likewise, the lid part 18 also has an outer rim 53 which projects downwards. The outer rim 53 of the lid part 18 forms a click-fit coupling with the outer rim 52 of the basin part 20.

The bedpan comprises at least a first support leg 24 and a second support leg 25 which extend downward from the upper wall 22. This embodiment has two right support legs 24 on the right side and two left support legs 25 on the left side of the bedpan 10. Each support leg comprises a circumferential leg wall 28 which is connected at an upper end 29 thereof to the upper wall.

The circumferential wall 16 of the main basin 12 and the circumferential leg walls taper outwardly at a nesting angle of 1-8 degrees.

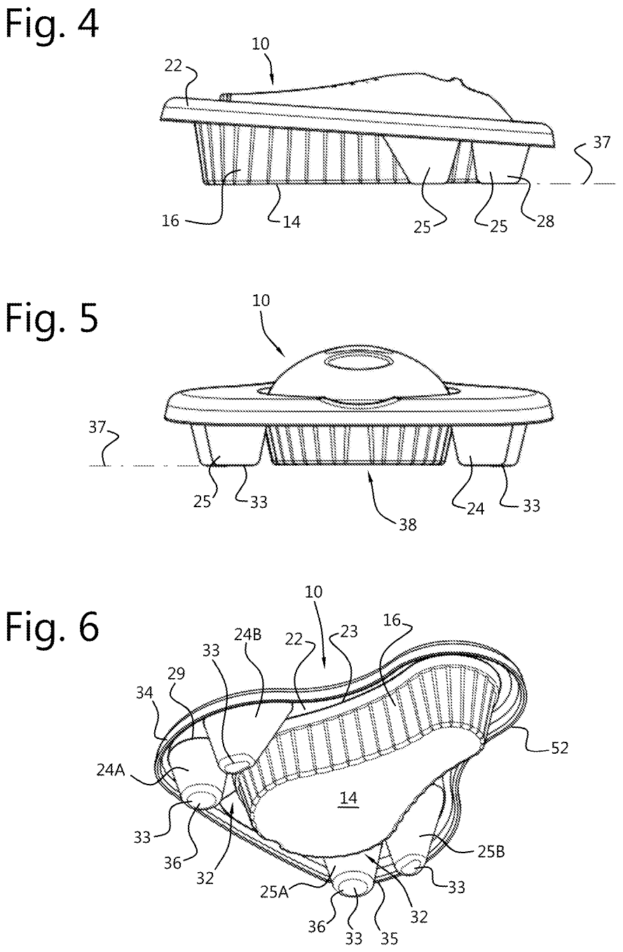

When seen in top view the first (or right) support legs 24 and second (left) support legs 25 are positioned at a rear half of the bedpan, see for instance FIG. 4.

The set of right legs 24 can be divided in a rear right leg 24A and a forward right leg 24B. Similarly, the set of left legs 25 can be divided in a rear left leg 25A and a forward left leg 25B.

At least one support leg 24 is positioned at a right rear corner 34 of the upper wall 22 and at least one support leg is positioned at a left rear corner 35 of the upper wall 22.

The legs 24, 25 do not form part of the circumference of the bedpan and do not form part of the outer rim 52 of the bedpan, but are located inward of the outer rim 52. An outer gap is located between the legs 24, 25 and the outer rim 52 which projects downwards.

When seen in top view one or more legs, in particular a right leg and a left leg, and in this embodiment the forward right leg 24B and the forward left leg 25B, have an elongate cross-section, a leg width (LW1) being smaller than a leg length (LW2).

Each circumferential leg wall 28 tapers outwardly in an upward direction. Each support leg 28 is hollow and defines a leg cavity 30. Each of the support legs has a leg bottom wall 36 which closes off a lower end of the support leg. The bottom wall of the main basin defines a reference plane 37. When seen in side view, the lower ends 33 of the support legs are located on said reference plane or located at a distance above said reference plane. The upper wall 22 defines a leg opening 31 at each upper leg, allowing nesting of support legs of different bedpans inside one another when a plurality of bedpans is stacked in a stack.

The gap 32 is defined between the respective support legs 24,25 and the circumferential wall 16 of the main basin. The gap 32 is defined between each circumferential leg wall 28 and the circumferential wall 16 of the main basin. The gaps may extend over the entire height of the support legs 24, 25. The gap 32 increases in width when traveling downward from the upper wall 22 and reach a maximum at the lower ends 33 of the support legs 24, 25. At each lower end 33 of each support leg 28 the gap 32 between the circumferential leg wall 28 and the circumferential wall 16 of the main basin is preferably 3-30 mm in a non-deformed state of the bedpan, preferably 4-20 mm, most preferably 5-10 mm.

The support legs 24, 25 are not directly connected to one another, but only via the upper wall 22. The support legs 24, 25 are not directly connected to the circumferential wall of the main basin, but only via the upper wall 22 of the basin part.

The support legs 24, 25 are of equal length or shorter than the wall 16 of the main basin 12.

In use, the support legs 24, 25 stabilize the bedpan 10 and the patient who rests on top of the bedpan 10.

Turning to FIG. 10, when seen in top view the main basin 12 comprises a forward basin region 40 and a rear basin region 41. The forward basin region 40 has a greater width W1 than the width W2 of the rear basin region.

The forward basin region 40 and the rear basin region 41 may be separated by a waist region 42. The waist region 42 interconnects the rear basin region 41 with the forward basin region 40. The width W2 of the rear basin region and the width W1 of the forward basin region 40 are greater than a width W3 of the waist region.

When seen in top view the rear basin region 41 has a rear basin centre (Cb), and wherein the cross section of each leg has a leg centre (C1, C2, C3 and C4). The two legs centres (C2, C4) of the rear legs are positioned to the rear of said rear basin centre.

The two leg centres (C1, C3) of the forward legs may be positioned forward of said rear basin centre.

When seen in top view the leg centres of the legs may be positioned relative to the rear basin centre Cb as follows: 1 to 3 o'clock position, 9 to 11 o'clock position, 3 to 6 o'clock position and 6 to 9 o'clock position, the 12 o'clock position being the centre forward direction.

When seen in top view, a cross-section of the leg cavities of some of the support legs 24B, 25B is curved, wherein a part 44 of the circumferential leg wall 28 that faces the circumferential wall 16 of the main basin 12 is concave and a part 45 of the circumferential wall that faces said concave part 44 is convex.

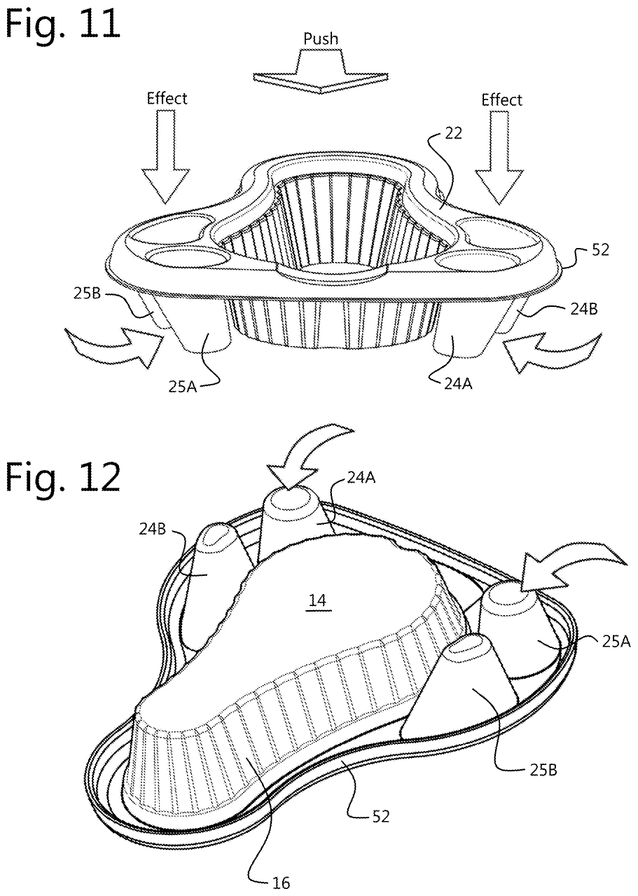

Turning to FIGS. 11 and 12, the bedpan 10 is deformable, in particular by the force required to push the bedpan 10 under the buttocks of a user, allowing the support legs 24, 25 to pivot inward towards the circumferential wall 16 of the main basin. The forces are compression forces, angle forces and shear forces. Especially the shear forces may be problematic. The pulp material of the bedpan has the tendency to tear when being pushed sideways under the buttocks of the user under a heavy load. The mattress is not a straight surface, but will be dented and is wobbly. The mattress provides a stiff resistance against the sideways movement of the bedpan.

As a result, the gap 32 reduces and at least partially disappears as a result of the pivoting movement. As a result of the deformation at least some of the support legs 24, 25, and possible all of the support legs engage the circumferential wall 16 of the main basin 12 and find support against the circumferential wall of the main basin. The upper wall 22 flexes during the deformation.

The four support legs 24, 25 are configured to flex inwardly, wherein the two forward support legs (24B, 25B) are configured to find support against respective portions of the circumferential wall of the basin which face outwardly and forwardly and wherein the two rear support legs (24A, 25A) are configured to find support against respective portions of the circumferential wall of the basin which face outwardly and rearwardly. This engagement increases the strength and the rigidity of the bedpan during the movement underneath the buttock of the user and enhances the sliding motion of the bedpan over the mattress as the bent legs form a curved, more rounded shape when flexed against the main basin. Normally, reinforcement ribs are used to create strength. However, although reinforcement ribs are generally very useful for compression forces they are less useful for shear forces. As a result of the flexing of the support legs, the bedpan is less vulnerable to shear forces.

The inward flexing movement of the support legs also lowers the height of the bedpan at the rear side. This further facilitates the sideways movement of the bedpan underneath the buttocks of the user. It also advantageously means that users/patients who not need to raise themselves as high as they would for a conventional bedpan. This shape of the bedpan is also more curved which makes it easier to slide underneath the buttocks. Alternatively, the user/patient can be rolled onto the bedpan 10. The bedpan 10 is strong enough to carry this load.

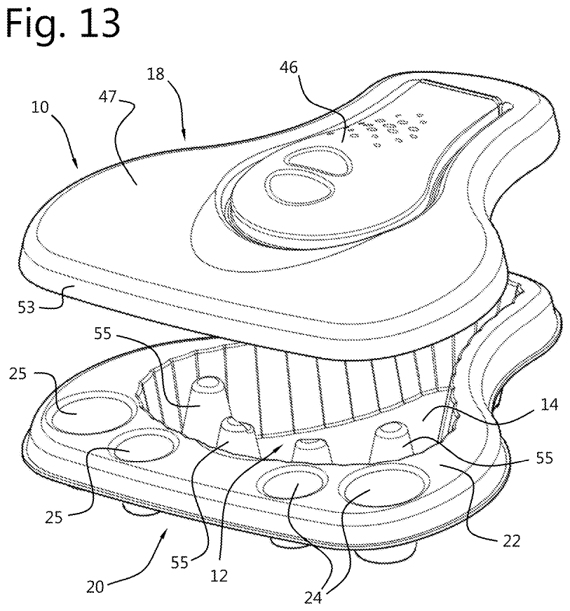

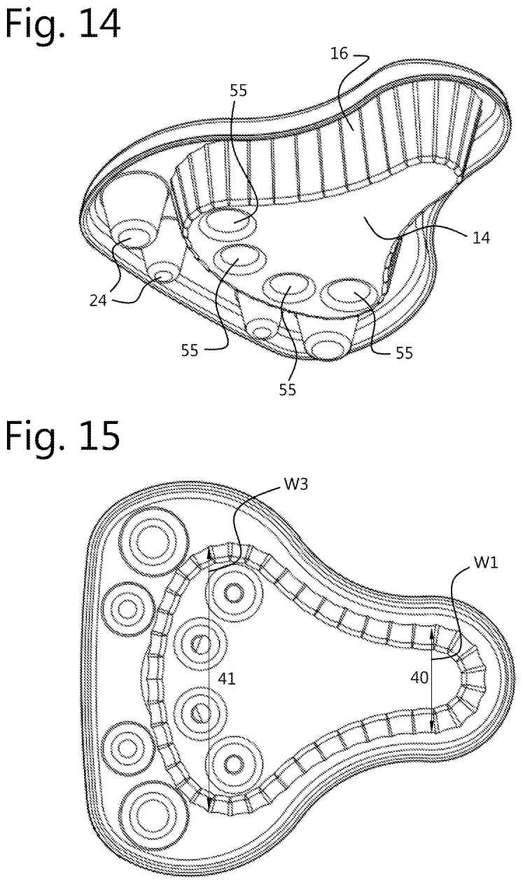

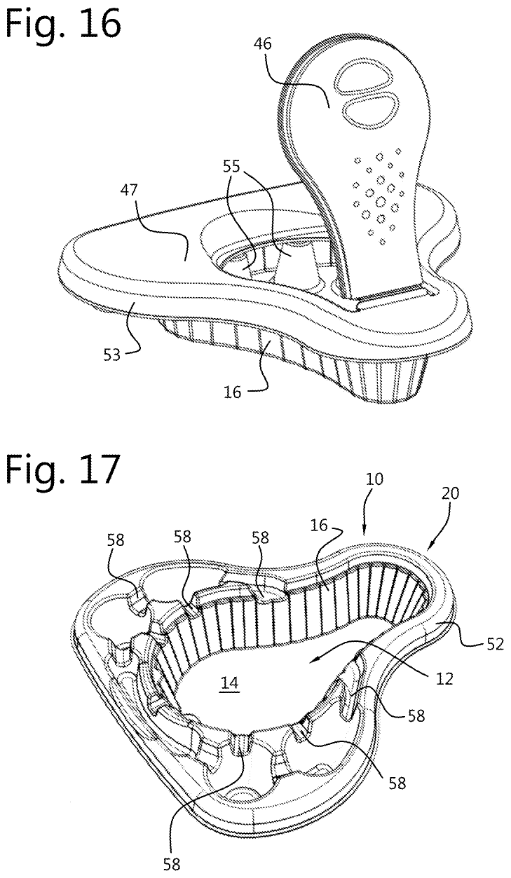

Turning in particular to FIGS. 13, 14 ,15 and 16, a further embodiment of the bedpan 10 is shown. In this embodiment, the support legs 24, 25 are positioned more to the rear of the main basin 12 than in the previous embodiment. This embodiment is particularly useful for patients that cannot lift their buttocks and must lie down straight when using the bedpan. The area 47 of the cover 18 avoids patients to touch the contents with their buttocks. The liquids can run in the cavity 12 which is covered by area 47 of cover 18.

Furthermore, additional support legs 55 rise up from the bottom wall 14 of the main basin 12. There are four additional support legs 55, but obviously the number may vary. The additional support legs 55 are tapered. The additional support legs 55 provide support for the cover section 47 of the lid part 18. The additional support legs 55 are open at the bottom and closed at the top. The tapering direction of the additional support legs 55 is reversed with respect to the tapering direction of the support legs 24, 25. The additional support legs 55 tapered inwardly in an upward direction, the support legs 24, 25 taper outwardly in an upward direction.

In this embodiment, the forward region of the main basin 12 is narrower than in the first embodiment. In particular, the forward region 40 has a width W1 which is less than 60 percent of the width W3 of the rear region 41. The height of the basin 12 is typically also lower in this embodiment so that the bedpan can be used when a patient lies down without moving up the hips.

Turning to FIG. 17, in another embodiment, the bedpan 10, in particular the basin parts 20 thereof, comprising one or more overflow channels 58 which form a depression in the upper wall 22 and which extend between the support legs 24, 25 and the main basin 12. If, in use the main basin 12 overflows, the urine (or other liquid) will flow into the support legs 24, 25 via the overflow channels 58. The overflow channels may obviously also be applied in the first and second embodiment.

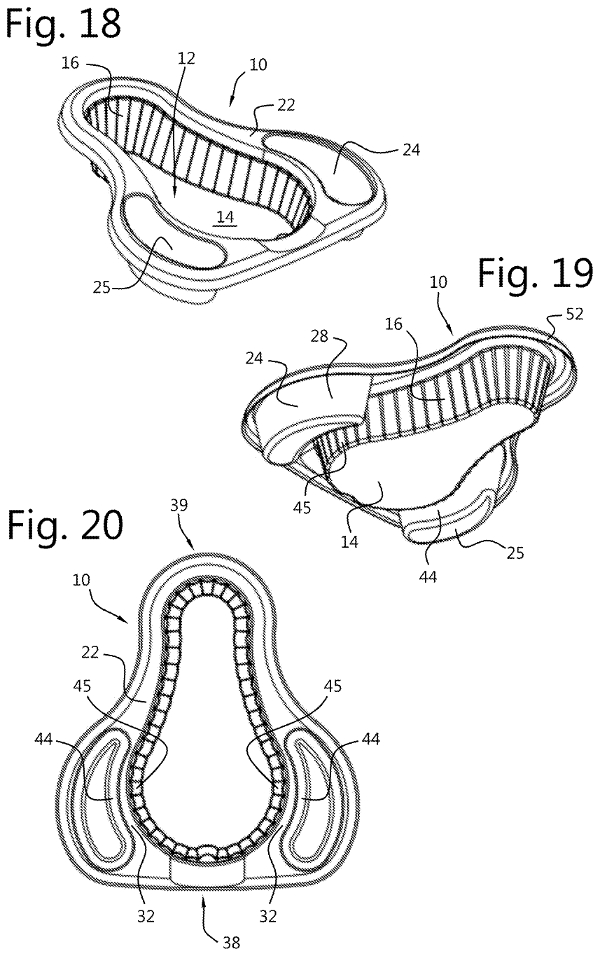

Turning to FIGS. 18, 19, 20, in another embodiment, the bedpan 10 comprises only two support legs 24, 25. The support legs 24, 25 are positioned more to the side of the main basin 12. When seen in top view, the cross-section of the leg cavities of the two support legs 24, 25 are curved. The circumferential side walls 28 of the support legs 24, 25 comprise a concave section 44 which faces the circumferential wall 16 of the main basin 12. When the bedpan is moved underneath the buttocks of a user, the deformation will cause the support legs to move towards the circumferential wall of the main basin, thereby closing the gap 32 in a similar way as in the previous embodiments.

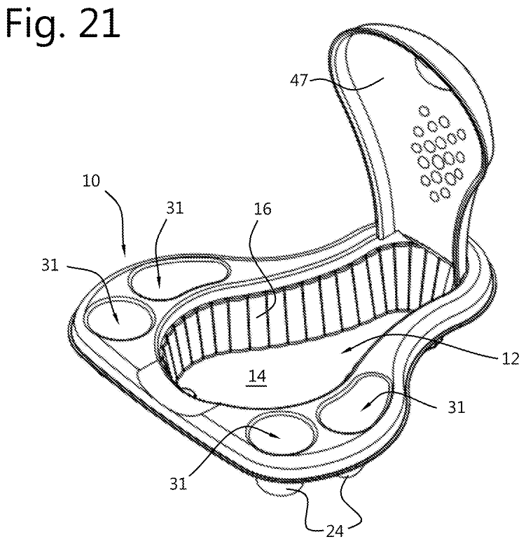

Turning to FIG. 21, in another embodiment, the bedpan 10 is a single-part bedpan. The bedpan does not comprise a separate lid part, but the lid 47 is integrated in the (lower) basin part 20. In this embodiment, the upper ends 31 of the support legs 24, 25 are open and are not covered by anything.

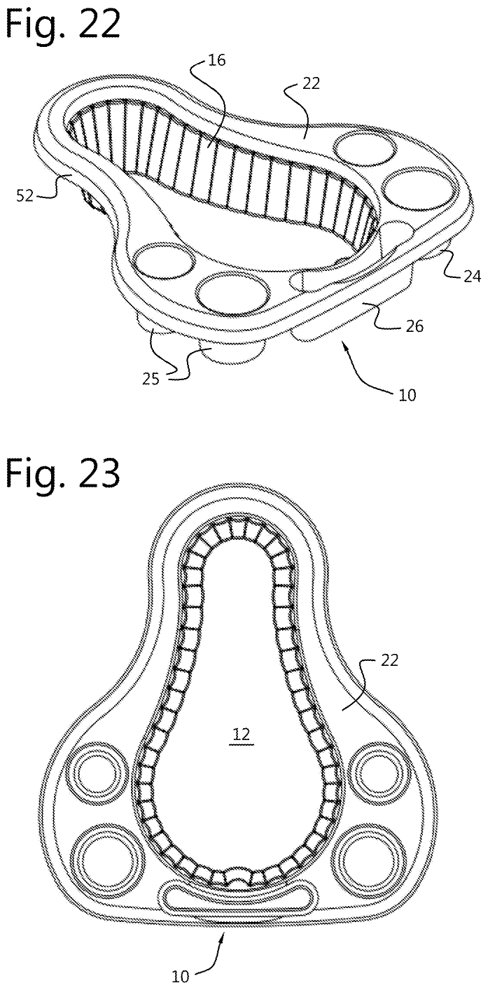

Turning to FIGS. 22 and 23, in another embodiment, the bedpan 10 is a single-part bedpan. The bedpan does not comprise a separate lid part. In this embodiment five support legs 24, 25 and 26 are provided. The fifth support leg 26 is located centrally at the rear end of the bedpan 10.

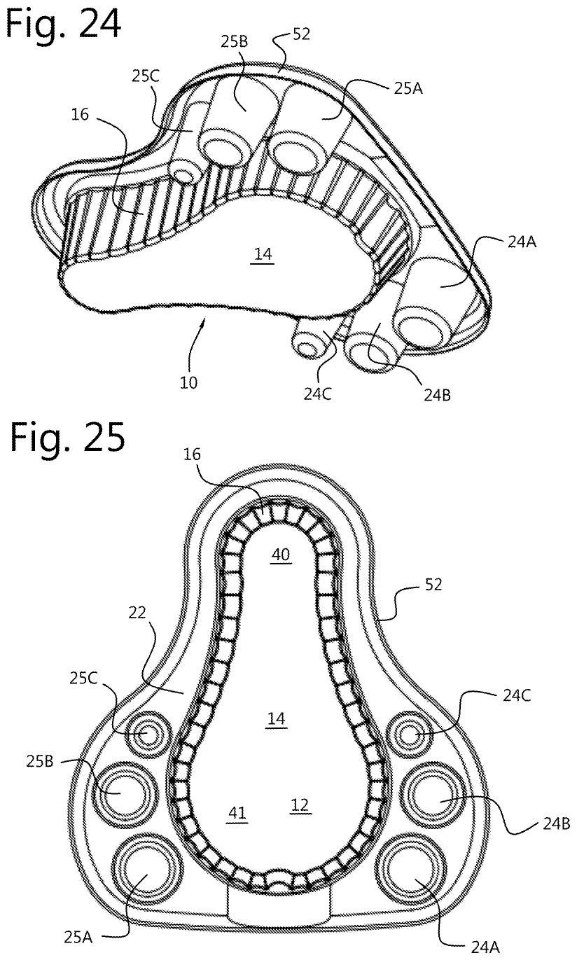

Turning to FIGS. 24 and 25, in yet another embodiment, the bedpan 10 is a single-part bedpan. The bedpan does not comprise a separate lid part. In this embodiment six support legs 24A, 24B, 24C, 25A, 25B, 25C are provided. The six support legs are positioned around the rear region 41 of the main basin 12.

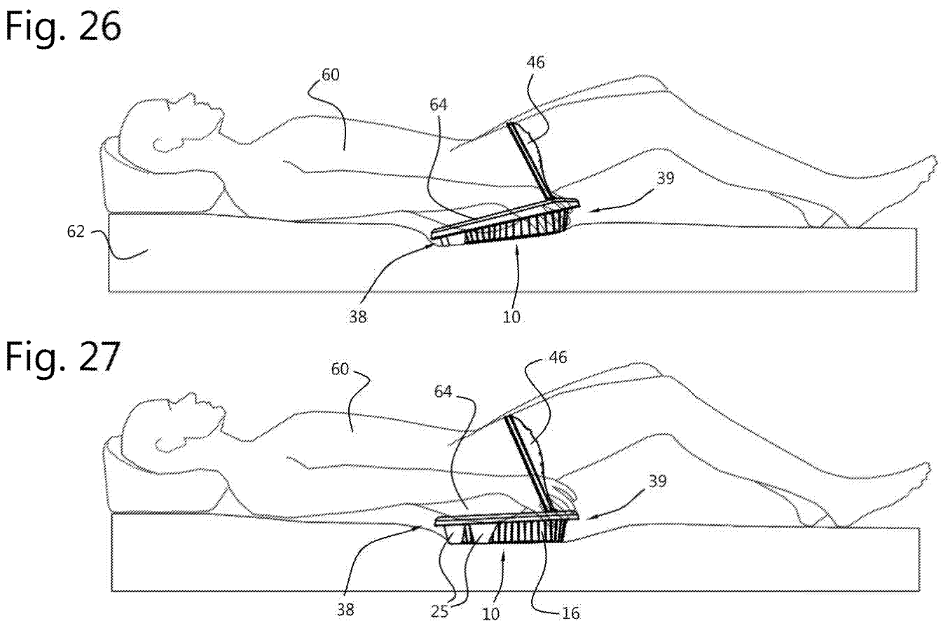

Turning to FIGS. 26 and 27, the bedpan 10 is shown in use. A user 60 lies on a mattress 62 of a bed. The bedpan 10 is pushed underneath the buttocks 64 of the user. A depression is formed in the mattress as a result of the user pressing the bedpan downwards. The optional lid 46 is pivoted upwards and positioned in front of the crotch of the user. The lid 46 forms a splash guard for urine.

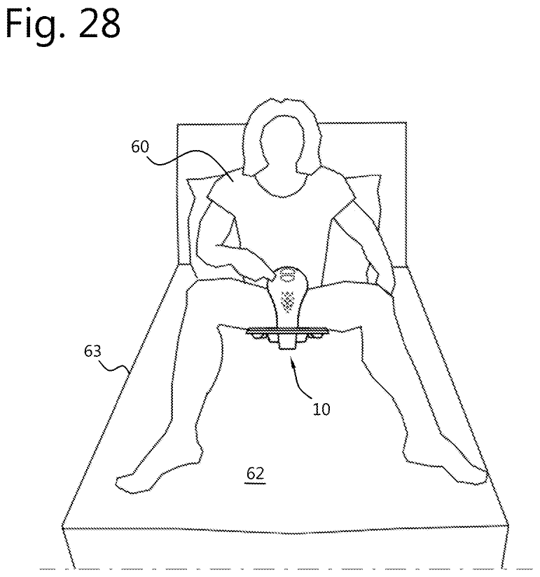

Turning to FIG. 28, the bedpan 10 may also be used by a user 60 who sits in a bed 63.

The bedpan 10 is capable of supporting patients up to a weight of 100-150 kg, depending on the thickness of the pulp and the pulp-material. Preferably the bedpan can hold this weight without the use of a separate reusable plastic support. The bedpan 10 can be macerated with standard macerators such as supplied by DDC Dolphin (UK), Haigh Engineering (UK), Vernacare (UK), or Hygienius (NL).

Naturally, the bedpan 10 may comprise further reinforcement ribs curves or structures to further increase the strength.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising i.e., open language, not excluding other elements or steps.

Any reference signs in the claims should not be construed as limiting the scope of the claims or the invention. It will be recognized that a specific embodiment as claimed may not achieve all of the stated objects.

The mere fact that certain measures are recited in mutually different dependent claims does not indicate that a combination of these measures cannot be used to advantage.

White lines between text paragraphs in the text above indicate that the technical features presented in the paragraph may be considered independent from technical features discussed in a preceding paragraph or in a subsequent paragraph.

1-29. (canceled)

30. A single-use bedpan, comprising:
a main basin that is defined by a bottom wall and a circumferential wall which is connected to the bottom wall and which extends upwards from the bottom wall, wherein the circumferential wall tapers outwardly in an upward direction, allowing nesting in a stack;
an upper wall which is connected to an upper edge of the circumferential wall, wherein the upper wall extends over a horizontal distance outwardly away from said upper edge; and
at least a first support leg and a second support leg which extend downward from the upper wall, wherein each support leg comprises a circumferential leg wall which is connected at an upper end thereof to the upper wall, wherein each circumferential leg wall tapers outwardly in an upward direction, wherein each support leg is hollow and defines a leg cavity, and wherein the upper wall defines a leg opening at each support leg, allowing nesting of support legs of different bedpans inside one another when a plurality of bedpans is stacked in a stack, wherein a gap is defined between each circumferential leg wall and the circumferential wall of the main basin.

31. The Bedpan according to claim 30, wherein the bedpan is deformable, in particular by the force required to push the bedpan under the buttocks of a user, allowing the support legs to pivot inward towards the circumferential wall of the main basin, wherein the gap reduces and at least partially disappears as a result of the pivoting movement, and wherein as a result of the deformation the support legs engage the circumferential wall of the main basin and find support against the circumferential wall of the main basin.

32. The bedpan according to claim 30, wherein at each lower end of each support leg the gap between the circumferential leg wall and the circumferential wall of the main basin is 3-30 mm in a non-deformed state of the bedpan, preferably 4-20 mm, most preferably 5-10 mm.

33. The bedpan according to claim 30, wherein the gaps between the respective support legs and the circumferential wall of the main basin extend over the entire height of the support legs.

34. The bedpan according to claim 30, wherein the support legs are not directly connected to one another, but only via the upper wall.

35. The bedpan according to claim 30, wherein the bottom wall of the main basin defines a reference plane, and when seen in side view the lower ends of the support legs are located on said reference plane or at a distance above said reference plane.

36. The bedpan according to claim 30, wherein the first support leg is positioned on a right side of the bedpan and the second support leg is positioned on a left side of the bedpan.

37. The bedpan according to claim 30, wherein when seen in top view at least the lower ends of the first and second support legs are positioned at a rear half of the bedpan.

38. The bedpan according to claim 30, wherein at least one support leg is positioned at a right rear corner of the upper wall and at least one support leg is positioned at a left rear corner of the upper wall.

39. The bedpan according to claim 30, wherein when seen in top view the forward right leg and the forward left leg have an elongate cross-section, a leg width being smaller than a leg length.

40. The bedpan according to claim 30, wherein the gaps between the circumferential walls of the respective support legs and the circumferential wall of the main basin increases when traveling downward from the upper wall and reaches a maximum at the lower ends of the support legs.

41. The bedpan according to claim 30, wherein when seen in top view the main basin comprises a rear basin region and a forward basin region and a waist region, wherein a width of the forward basin region is smaller than a width of the rear basin region, wherein in particular the waist region interconnects the rear basin region with the forward basin region, and wherein the rear width of the rear basin region and a forward width of the forward basin region are greater than a width of the waist region.

42. The bedpan according to claim 30, comprising exactly four support legs, two right support legs, and two left support legs, wherein the four support legs are configured to flex inwardly, wherein the two forward support legs are configured to find support against respective portions of the circumferential wall of the basin which face outwardly and forwardly, and wherein the two rear support legs are configured to find support against respective portions of the circumferential wall of the basin which face outwardly and rearwardly.

43. The bedpan according to claim 30, wherein when seen in top view a cross-section of the leg cavities of at least some of the support legs is curved, wherein a part of the circumferential leg wall that faces the circumferential wall of the main basin is concave and a part of the circumferential wall that faces said concave part is convex.

44. The bedpan according to claim 30, wherein the bedpan is a single-part bedpan, or wherein the bedpan comprises a basin part and a separate lid part.

45. The bedpan according to claim 30, wherein the circumferential wall of the main basin, the bottom wall of the main basin, the upper wall, and the circumferential leg wall of the support legs are integral with one another.

46. The bedpan according to claim 30, wherein the bedpan is manufactured from a pulp material, and wherein the bedpan is maceratable.

47. The bedpan according to claim 30, wherein the upper wall comprises an outer rim, and wherein the legs do not form part of the outer rim of the bedpan and are located to the inside of the outer rim.

48. The bedpan according to claim 30, further comprising one or more overflow channels which form a depression in the upper wall and which extend between the support legs and the main basin.

49. The bedpan according to claim 30, comprising two, three, four, five, six or more support legs.
